(19) United States
(12) Patent Application Publication
(10) Pub. No.: US 2006/0093403 A1
(43) Pub. Date: May 4, 2006

(54) Color image developing device

(75) Inventor: Tetsuo Tanda, Osaka (JP)

Correspondence Address: SHINJYU GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 11/163,778

(22) Filed: Oct. 31, 2005

(30) Foreign Application Priority Data
Oct. 29, 2004 (JP) 2004-316784

(51) Int. Cl. G03G 15/01

(52) U.S. Cl. 399/227

(57) ABSTRACT

A full color image developing device for a color printer is disclosed, in which a black developing unit employs a magnetic one-component developing system, and color developing units (except for black) employ a non-magnetic one-component toner. The diameters of the non-magnetic developing rollers are set smaller than those of the magnetic developing roller. This configuration makes it possible to extend the lifespan of the color printer as well as reduce the size and cost thereof.

### BACKGROUND OF THE INVENTION

1. Field of the Invention

The present invention relates to an image developing device, and more particularly to a full color image developing device in a full color image forming device.

2. Background Information

An image forming device utilizing an electrophotographic system includes a photosensitive drum as an image bearing member and other devices located circumferentially around the drum, such as a charger, an exposure device, a developing device, a transfer device, a cleaning device, and so on. In addition, a fixing device is provided downstream of the photosensitive drum in the direction in which transfer media is conveyed. In this image forming device, first, a surface of the photosensitive drum is uniformly charged by the charger. Then, the photosensitive drum is exposed by the exposure device in accordance with image data so that an electrostatic latent image is formed on the photosensitive drum. The electrostatic latent image is developed by the developing device. In the case of a full color image forming device, four developing units are provided which contain cyan developer, magenta developer, yellow developer, and black developer. The developing units develop the latent image to a toner image with four colors (cyan, magenta, yellow, and black). After that, the toner image is transferred to transfer media by the transfer device, fixed to the transfer media by the fixing device, and the transfer media is finally discharged to a discharge unit. Residual developer remaining on the photosensitive drum is cleaned by the cleaning device.

Recently, as full color image forming devices have been increasingly used by individuals, there have been demands for the size and the cost of the image forming device to be reduced. It is necessary to reduce the size of the developing device in order to reduce the size of the image forming device. There are two kinds of development system for the developing device. One is a two-component development system using carrier and toner. The other is a one-component development system using a one-component developer not including carrier. In the one-component development system, it is not necessary to have an agitation mechanism for agitating the carrier and the toner in the two-component development system because the one-component developer does not use carrier, and thus the structure of the development will be simple and it is easy to reduce the size. Furthermore, it is not necessary to have sensors for controlling the toner concentration, and thus costs can also be reduced.

The one-component developer is classified into magnetic one-component toner and non-magnetic one-component toner. The magnetic one-component toner contains toner that has a dark color, and thus magnetic one-component toner is not suitable as color toner requiring color reproducibility. Accordingly, a development system utilizing a non-magnetic one-component toner has been proposed in a full color image device, in which the non-magnetic one-component toner is used as well as cyan developer, magenta developer, yellow developer, and black developer (Japanese Unexamined Patent Publication No. 10-161335).

Another technology has been proposed in which the cyan developer, magenta developer, and yellow developer employ a non-magnetic one-component toner, and the black developer employs a magnetic one-component toner so as to adjust the degree of brilliance of the image to be formed (Japanese Unexamined Patent Publication No. 7-120996).

In a development system utilizing a non-magnetic one-component toner, typically, a toner control blade is brought into contact with the developing roller which conveys the toner to the image bearing member, so that the toner control blade charges the toner as well as controls the toner layer on the developing roller. After development, a sponge roller is pressed against the developing roller so as to remove the developer remaining on the developing roller. Accordingly, the developing roller is likely to be worn.

At work sites where color image forming devices are used, monochrome image formation is typically performed much more than full color image formation because of printing costs. As a result, the black developing unit for forming monochrome images is more frequently used compared to full color images. If a non-magnetic one-component toner is used in the black developing unit as in Japanese Unexamined Patent Publication No. 10-161335, the developing roller of the black developing unit is worn more than the other developing rollers of the color developing units, and will have a shorter lifespan.

On the contrary, in a development system using a non-magnetic one-component toner, the control blade for controlling the toner layer on the developing roller is not in contact with the developing roller, and thus the developing roller is less worn compared to the non-magnetic one-component development system. In addition, even if a magnetic one-component toner having a dark color magnetic substance is used for the black developing unit, it is unlikely to affect image quality.

As noted above, in a development system utilizing a non-magnetic one-component toner, typically, the toner control blade is brought into contact with an outer circumference of the developing roller which conveys the toner to the image bearing member, so that the toner control blade charges the toner as well as controls the toner layer on the developing roller. After development, the sponge roller is pressed against the outer circumference of the developing roller so as to remove the developer remaining on the developing roller. Consequently, the torque required for rotating the non-magnetic developing roller is two to three times the torque required for rotating the magnetic developing toner. If the diameters of the non-magnetic developing rollers are the same as those of the magnetic developing roller as shown in Japanese Unexamined Patent Publication No. 7-120996, the driving mechanism used to drive the devices will be large because the torque required for rotating the non-magnetic developing rollers is large.

It is an object of the present invention to provide a full color image developing device that can have a long lifespan, and in which the size and cost thereof is reduced.

### SUMMARY OF THE INVENTION

An image developing device according to a first aspect of the present invention is located facing an image bearing member for developing a color toner image with a plurality of color toners. The device comprises a black developing unit having a magnetic developing roller for developing black toner images with a magnetic one component toner, and a plurality of color developing units having non-magnetic developing rollers for developing color toner images, except for black, with non-magnetic one-component toner. The diameters of the non-magnetic developing rollers are smaller than the diameter of the magnetic developing roller.

In the device, a one-component developing system is employed as well as a black developing unit and a color developing units. Although a two-component developing system requires sensors used for controlling toner concentration in the carrier, a one-component developer does not require sensors because a carrier is not used. Thus, costs can be reduced.

The black developing device has a magnetic developing roller and utilizes magnetic one-component black toner as a developer, so that the magnetic toner forms chains of particle clusters on the developing roller to form the developing layer. Accordingly, wear on the developing roller is controlled, while a developing device utilizing a non-magnetic roller developer requires pressing the developing layer controlling blade against the developing roller to form the developing layer. Accordingly, in the color image developing device, the lifespan of the black developing device, which is most frequently used, is extended. On the other hand, the color developing devices, except for the black, utilize non-magnetic one-component toner so that quality of the toner image will be assured.

In the device, the black developing unit has the magnetic developing roller and utilizes the magnetic one-component toner, while the color developing units, except for the black, have the non-magnetic rollers and utilize the non-magnetic one-component toner.

In addition, in a development system utilizing a non-magnetic one-component toner, typically, the toner control blade is brought into contact with the outer circumference of the developing roller which conveys the toner to the image bearing member, so that the toner control blade charges the toner as well as controls the toner layer on the developing roller. After the development, a sponge roller is pressed against on the outer circumference of the developing roller so as to remove the developer remaining on the developing roller. Consequently, the torque required for rotating the non-magnetic developing roller is two to three times the torque required for rotating the magnetic developing toner.

In order to solve the problem, the diameters of the non-magnetic developing rollers are set smaller than that of the magnetic developing roller so that the resisting torque generated by placing the toner control blade or the sponge roller into contact with the outer circumference of the non-magnetic developing rollers will be reduced, which means that the torque required for driving the non-magnetic developing roller is prevented from increasing.

According to a second aspect of the present invention, in the color image developing device according to the first aspect, the non-magnetic developing rollers include a solid roller main body, and a rubber layer formed on a surface of the roller main body.

In a development system utilizing the non-magnetic one-component toner, typically, the toner control blade is brought into contact with an outer surface of the developing roller which conveys the toner to the image bearing member, so that the toner control blade charges the toner as well as controls the toner layer on the developing roller. In the device, charge leakage from the surface of the developing roller will be controlled because the rubber layer, which has a higher resistance than the roller body, is mounted on the surface of the roller body.

According to a third aspect of the present invention, in the color image developing device according to the first or second aspects, the device further comprises a rotary frame which serves to align and maintain the black developing unit and the color developing units in the circumferential direction, and serves to place each of the developing units opposite the image bearing member by means of rotation.

In the device, the black developing unit and the color developing units are aligned and maintained by the rotary frame in the circumferential direction. During an image forming operation, the rotary frame rotates and sequentially moves each of the developing units into a developing position in the circumferential direction where the developing unit is opposite to the image bearing member for development. Accordingly, the developing device is reduced in size compared to a tandem system.

According to a fourth aspect of the present invention, in the color image developing device according to the first to third aspect, the color image developing device further comprises agitation members rotatably disposed in the developing units for agitating the toner, a magnetic developing roller driving gear mounted on an axial end of the magnetic developing roller of the black developing unit, non-magnetic developing roller driving gears mounted on axial ends of the non-magnetic developing rollers of the color developing units, agitation member driving gears fixed to axial ends of the agitation members and engaged with the roller driving gears, input gears for driving the driving gears, and intermediate gears engaged with the input gears and the agitation member driving gears of the developing units. The input gears of the developing units are located in the same position relative to the external driving mechanism. The positions of the agitation member driving gear and the intermediate gear relative to the input gear and the roller driving gear in the black developing unit are different from the positions of the agitation member driving gear and the intermediate gear relative to the input gear and the roller driving gear in the color developing units.

In the device, the diameters of the developing rollers of the black developing unit and the color developing units are different, so that the positions of the agitation members located adjacent to those developing rollers are different between the black developing unit and the color developing units. Meanwhile, the input gears of the developing units are located such that they keep the same positional relationship to an external driving mechanism for inputting driving force to the input gears. In conclusion, the positional relationships between the input gears and the agitation members are different between the black developing unit and the color developing units. In this device, the intermediate gear is located between the input gear and the agitation member driving gear so as to adjust the positional relationship between them. As a result, the driving force is smoothly transmitted from the input gears located in the common positions relative to the agitation member driving gears located in the different positions.

In the present invention, the black developing unit employs a magnetic one-component developing system, and the color developing units, except for black, employ a non-magnetic one-component toner, so that it is possible to extend the product lifespan of a full color image developing device as well as reduce the size and cost of a full color image developing device.

In addition, the diameters of the non-magnetic developing rollers are set smaller than that of the magnetic developing roller, so that resisting torque generated by placing the toner control blade or the sponge roller contact against the outer circumference of the non-magnetic developing rollers become smaller, which means that torque required for driving the non-magnetic developing rollers is prevented from increasing.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a schematic structural view of a color printer according to an embodiment of the present invention.

FIG. 2 is a sectional view of the developing unit.

FIG. 3 is a sectional structural view of the developing unit driving mechanism.

FIG. 4 is an external perspective view of the developing unit.

FIG. 5 is a perspective view of the developing unit driving mechanism.

FIG. 6 is a perspective view of the gear engagement of the developing unit driving mechanism.

FIG. 7 is a perspective view of the device showing the toner containers extracted halfway.

FIG. 8 is a detailed sectional structural view of the toner supply device.

### DETAILED DESCRIPTION OF THE PREFERRED EMBODIMENT

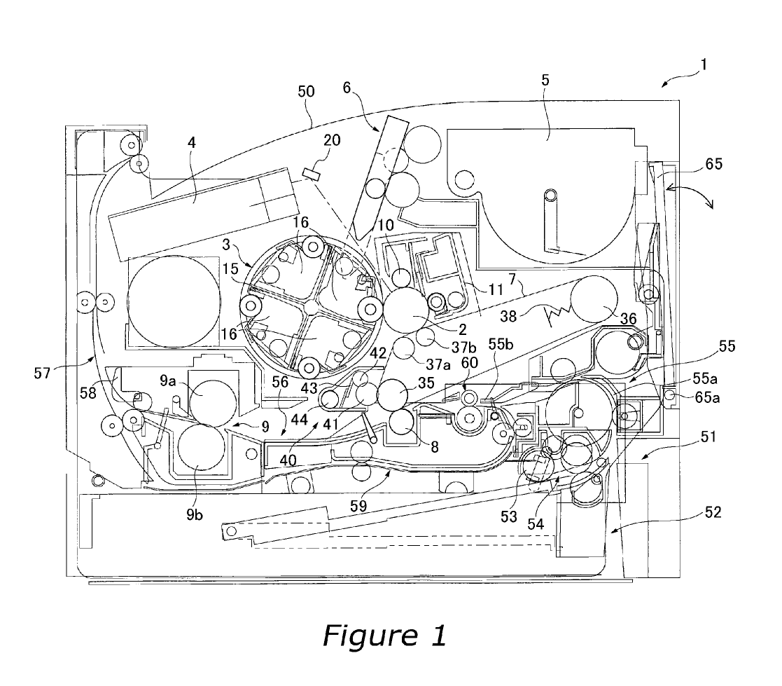

FIG. 1 shows a color printer 1 as a color image forming device according to one embodiment of the present invention. FIG. 1 is a view showing a frame format of the locations of each of the components, and details of each of the portions are omitted.

Overall Structure

The color printer 1 is connected to a computer, for example, and is capable of printing a color image on a sheet in accordance with image data sent from the computer. In this color printer 1, the right side of FIG. 1 is the side from which an operator operates the color printer 1. In the below description, the right side in FIG. 1 is referred to as the “front side” and the left side in FIG. 1 is referred to as the “rear side”.

The color printer 1 includes a photosensitive drum 2, a rotary developing device 3, a laser unit 4, a toner container 5, a toner supply device 6, an intermediate transfer belt 7, a secondary transfer roller 8, and a fixing device 9.

Photosensitive Drum

The photosensitive drum 2 has a surface on which an electrostatic latent image is formed, and is rotatably mounted substantially in the center of the device. The rotational axis of the photosensitive drum 2 is located such that the axis extends in a lateral direction seen from the front side of the device, i.e., perpendicular to the plane of FIG. 1. On an upper portion of the photosensitive drum 2, a charge roller 10 for uniformly charging a surface of the photosensitive drum 2 is mounted. On a lateral side of the photosensitive drum 2, a drum cleaning device 11 is mounted for cleaning residual toner and other matter on the surface of the photosensitive drum 2.

Rotary Developing Device

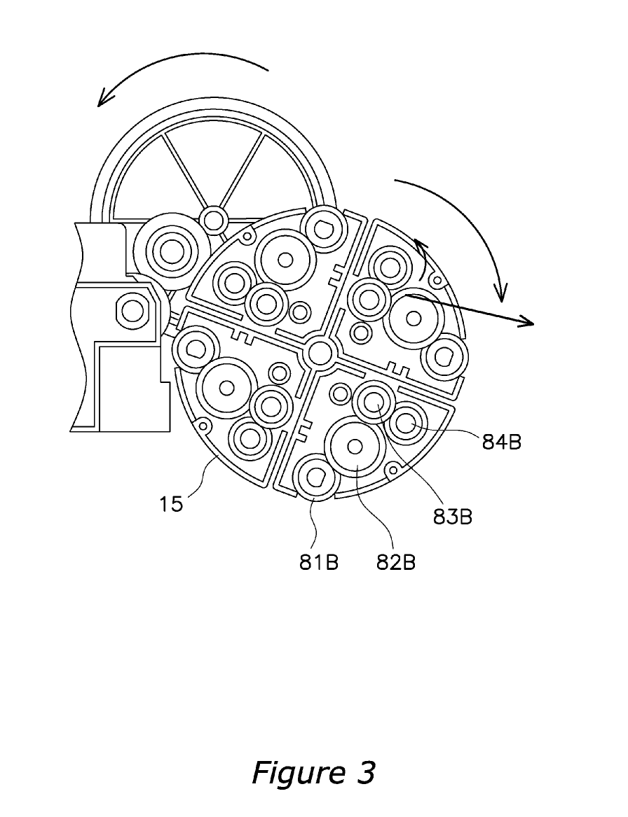

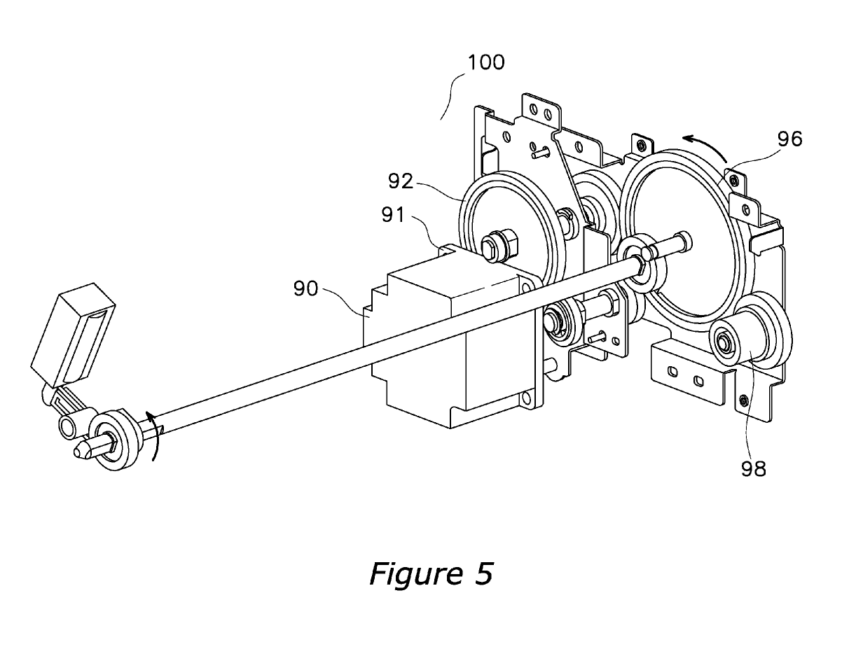

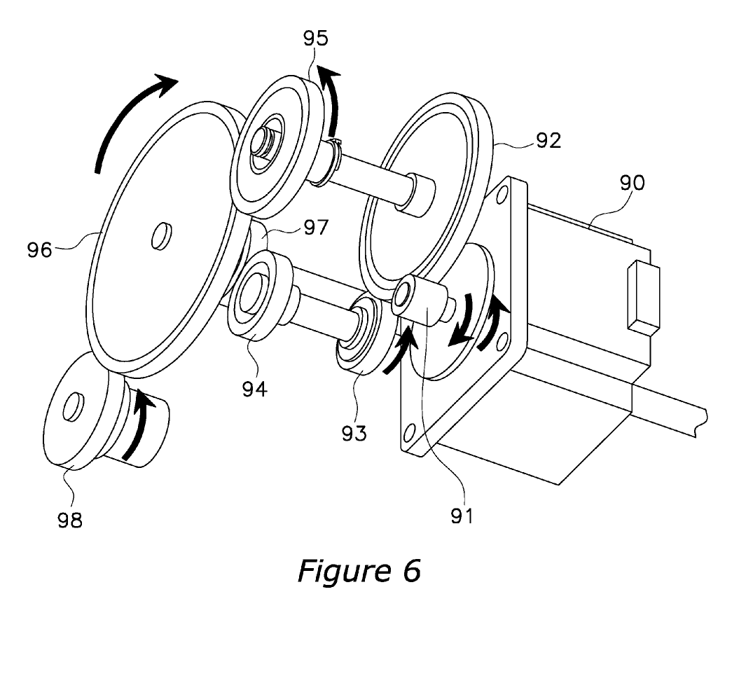

The rotary developing device 3 is a device for developing an electrostatic latent image formed on the photosensitive drum 2 with each color toner. The rotary developing device 3 is located adjacent to the photosensitive drum 2 and has a center substantially corresponding to the center of the photosensitive drum 2 in a vertical direction. The rotary developing device 3 includes a rotary frame 15, and four developing units 16 corresponding to four color toners and supported by the rotary frame 15. The rotary frame 15 is a cylindrical member rotatable around an axis in parallel with the rotational axis of the photosensitive drum 2 and is driven by a driving mechanism including a motor and a gear shown in FIG. 3 to 6.

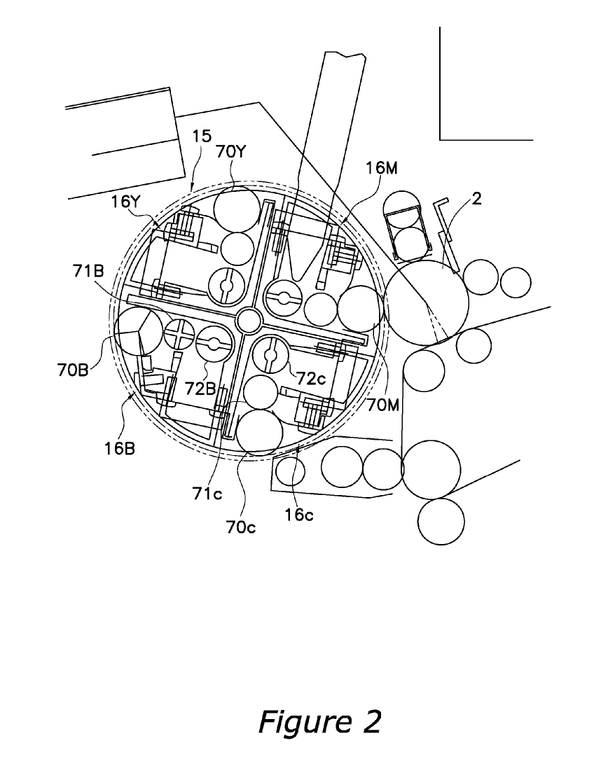

In addition, as shown in FIGS. 2 to 4, the rotary frame 15 is formed with four compartments divided into quarters by partitions extending from the center of the rotational axis radially outward. Each of the compartments accommodates each of the developing units 16 corresponding to four color toners such as yellow, cyan, magenta, and black. Each of the developing units 16 has a common structure, and includes a developing roller 70 capable of being located so as to be opposed to the photosensitive drum 2, a sliding contact roller 71, and an agitation roller 72 for agitating the toner. It should be noted that the diameter of the developing roller 70B of the black developing unit 16B is larger than those of the developing rollers 70Y, 70M, and 70C of the color developing units 16Y, 16M, and 16C.

Next, a driving mechanism 80 for the developing units will be described, referring to FIGS. 3 to 6. In the following description, although only the black developing unit 16B will be explained, its basic structures are common with the other color developing units 16Y, 16M, and 16C. The driving mechanism 80 includes a roller driving gear 81B, a paddle driving gear 82B, an intermediate gear 83B, and an input gear 84B. The roller driving gear 81B is fixed to an axial end of the developing roller 70B, and the paddle driving gear 82B is fixed to an axial end of a paddle such that the gears 81B and 82B are engaged with each other. The input gear 84B and the intermediate gear 83B are located in the same position with the other gears in the axial direction of the rotary frame 15, so that the input gears 84B are located so as to keep the same position in all of the developing units, i.e., in common positions which makes the same positional relationship to the external driving mechanism 100. The intermediate gear 83B is engaged with the input gear 84B and the paddle driving gear 82B.

The diameter of the developing roller 70B of the black developing unit 16B is larger than those of the developing rollers 70Y, 70M, and 70C of the other color developing units 16Y, 16M, and 16C, so that positions of the paddles are different between the black developing unit 16B and the color developing units 16Y, 16M, and 16C. Accordingly, the positions of the paddle driving gears 82 are also different. On the contrary, the input gear 84 are located in the same positions, so that it is impossible for the input gears 84 and the paddle driving gears 82 to be engaged with each other to directly transmit turning force. In this embodiment, the intermediate gear 83 is located between the input gear 84 and the paddle driving gear 82. Although the positional relationship of the input gear 84 and the paddle driving gear 82 in the black developing unit 16B and positional relationship of the input gear 84 and the paddle driving gear 82 in the color developing units 16Y, 16M, and 16C are different, the location of the intermediate gear 83 makes it possible for the input gear 84 and the paddle driving gear 82 to transmit turning force between them.

Next, an external driving mechanism 100 for driving the developing units will be described. The external driving mechanism 100 drives the rotary frame as well.

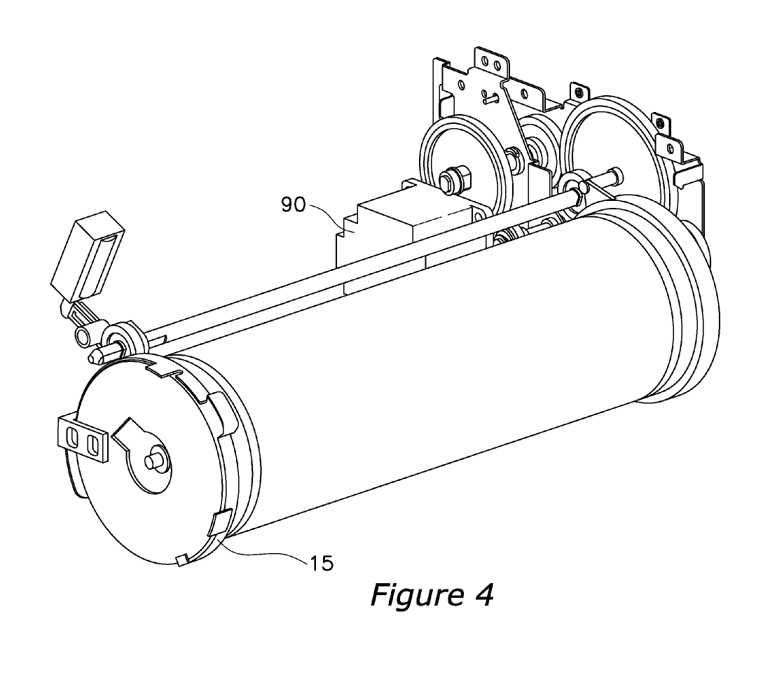

As shown in FIGS. 4 to 6, the external driving mechanism 100 includes a motor 90, a train of gears 91 to 96, a rotary frame driving gear 97, and a developing unit driving gear 98. The motor 90 is fixed to a frame of the device. The train of gears includes a first gear 91 fixed to an output shaft of the motor 90, a second gear 92 engaged with the first gear 91, a third gear 93 engaged with the second gear 92, a fourth gear 94 located coaxially with the third gear 93 and rotating in synchronization with the third gear 93, and a rotary frame driving gear 97 engaged with the fourth gear 94. The rotary frame driving gear 97 is engaged with a rotary frame gear (not illustrated) mounted on an axial end of the rotary frame 15 so that the rotary fame 15 is rotated. After the rotary frame 15 is rotated to a predetermined position, the rotational direction of the motor 90 is reversed. The third gear 93 has a built-in one-way clutch inside so that the third gear 93 rotates but the axis does not rotate.

In addition, the train of gears also includes a fifth gear 95 located coaxially with the second gear 92 and rotating in synchronization with the second gear 92, a sixth gear 96 engaged with the fifth gear 95, and a developing unit driving gear 98. The developing unit driving gear 98 is engaged with the input gear 84 on the developing unit side. The fifth gear 95 also has a built-in one-way clutch so that the fifth gear 95 does not rotate in the normal rotation of the motor 90 but rotates in the reverse rotation of the motor 90 so as to transmit driving force to the developing unit driving gear 98.

Laser Unit

The laser unit 4 is a device to scan and expose the photosensitive drum 2 in accordance with image data sent from the external computer, and is located above the photosensitive drum 2 and on the rear side of the rotational axis of the rotary developing device 3. More specifically, the front end of the laser unit 4, this end from which laser light is emitted, is located immediately above the rotational axis of the rotary developing device 3, and the rear end thereof is located below the upper end of the rotary developing device 3, with the whole of the laser unit 4 slanting downward toward the rear end. The inner construction of the laser unit 4 is common with that of conventional laser units, and includes a laser light source, a polygon mirror, a motor for driving the polygon mirror, and so on. In addition, on the front side of the laser light path from the laser unit 4, a reflective mirror 20 is provided so that the laser light emitted from the laser unit 4 is reflected by the reflective mirror 20, then passes on the front side of and above the rotary developing device 3, and is finally applied to the surface of the photosensitive drum 2 as shown in dotted lines in FIG. 1.

Toner Container

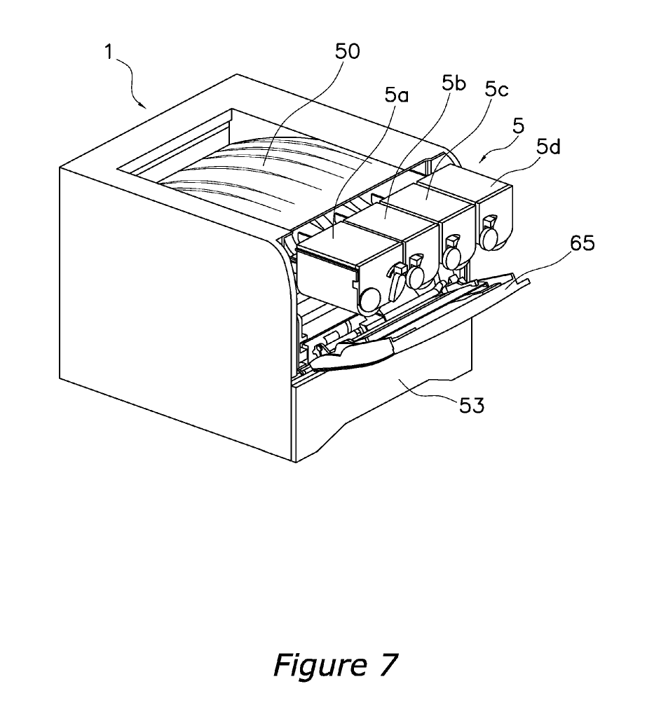

The toner container 5 is a member for storing toner to be supplied to each of the developing units 16 of the rotary developing device 3, and is located above the photosensitive drum 2 and on a side opposite to the laser unit 4 (on a front side in the device). The toner container 5 includes, as shown in FIG. 7, four containers 5a, 5b, 5c, and 5d arranged in a lateral direction, i.e., in a direction perpendicular to the plane of FIG. 1, for storing color toner such as yellow, cyan, magenta, and black. The toner container 5 can be pulled out toward the front side of the device.

Toner Supply Device

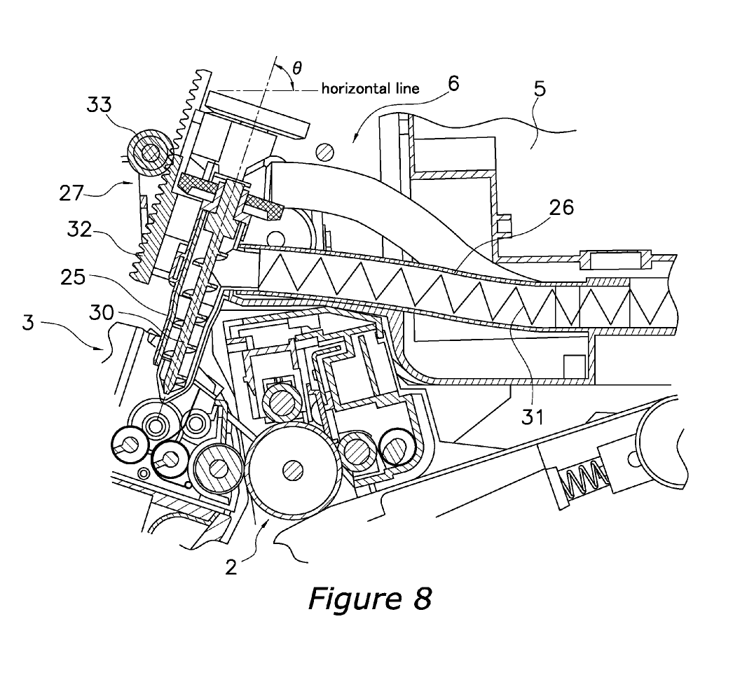

The toner supply device 6 is a device to supply each of the toners stored in the toner container 5 to the corresponding developing units 16, and is located above the photosensitive drum 2 and in a space between the laser unit 4 and the toner container 5. The toner supply device 6 includes, as shown in FIG. 8, four toner supply pipes 25 that are vertically movable, four conveyance pipes 26 for connecting portions containing each color toner in the toner container 5 with the corresponding toner supply pipes 25, and a drive mechanism 27 for moving the toner supply pipes 25 vertically.

Each toner supply pipe 25 extends vertically and is inclined such that an upper end is on the front side in the device and a lower end is on the rear side in the device. The toner supply pipe 25 has a tapered tip, which can advance into the inside of the developing unit 16 through the slit 18a of the toner supply portion 18 when the toner supply pipe 25 moves downward. Inside of the toner supply pipe 25, a spiral member 30 for conveying the toner is rotatably installed.

The conveyance pipe 26 is flexible enough to allow the pipe 26 to follow the vertical movements of the toner supply pipe 25. Inside of the conveyance pipe 26, a coil spring 31 is provided for conveying the toner to the toner supply pipe 25 within the conveyance pipe 26 when the coil spring 31 is rotated by a drive mechanism (not illustrated).

The drive mechanism 27 includes racks 32 provided on the outer circumference of the toner supply pipes 25 extending in the axial direction of the pipes 25, and pinion gears 33 engaged with the racks 32. The pinion gears 33 are rotatably supported by a frame of the device and are driven by motors (not illustrated).

The drive mechanism 27 makes it possible for the four toner supply pipes 25 to move between a retracted position upward shown in solid lines in FIG. 1 and a supply position downward shown in double-dashed lines in FIG. 1, wherein the tip is inserted into the developing unit 16. As mentioned above, the laser light of the laser unit 4 passes above and on the front side of the rotary developing device 3. Namely, the laser light path and moving paths of the toner supply pipes 25 are crossed with each other so that although the laser light path is not blocked by the toner supply pipes 25 when the toner supply pipes 25 is positioned in the retracted position, the laser light path is blocked by the toner supply pipe 25 when the toner supply pipe 25 is positioned in the supply position.

The toner supply pipe 25 has a shutter mechanism which opens only when the toner supply pipe 25 is positioned in the supply position. More specifically, the toner supply pipe 25 has an overlapped structure of an inner cylinder and an outer cylinder, and tips of the cylinders are formed with an opening having a circumferential length. In addition, the outer cylinder is formed with a protruding portion engaged with a rotary cam having a spiral groove located around the outer cylinder. When the toner supply pipe 25 is in the retracted position upward, the openings of the inner cylinder and the outer cylinder do not overlap with each other (shutter closed) so that the toner does not leak out. Meanwhile, when the toner supply pipe 25 moves downward, the outer cylinder rotates by means of the protruding portion and the rotary cam, the tip of the toner supply pipe 25 is inserted into the developing unit 16. Then, when the toner supply pipe 25 reaches the supply position, the openings of the inner cylinder and the outer cylinder overlap with each other (shutter opened) so that the inside toner is supplied to the inside of the developing unit 16 from the openings.

Intermediate Transfer Belt

The intermediate transfer belt 7 is a member on which the toner images in each color formed on the photosensitive drum 2 are sequentially transferred and is located below the photosensitive drum 2 and the toner container 5. The intermediate transfer belt 7 is looped over a driving roller 35 and a follower roller 36 located in the opposite directions. A portion of the transfer belt 7 facing the photosensitive drum 2 is constructed so as to be brought into contact with the photosensitive drum 2 by a pair of primary transfer rollers 37a and 37b.

The arrangement of the above-mentioned components will be described in more detail. The driving roller 35 is located immediately below contact portions of the photosensitive drum 2 and the rotary developing device 3, and the center is positioned below the lowest end of the rotary developing device 3. The driving roller 35 is driven by a driving unit including a motor and a gear (not illustrated). The follower roller 36 is located adjacent to a bottom of the toner container 5 and on the front side in the device, and its position in a vertical direction is substantially the same with a position of the photosensitive drum 2. The follower roller 36 is urged by a spring 38 in the direction opposite to the driving roller 35 so that the intermediate transfer belt 7 is tensioned. In addition, the primary transfer rollers 37a and 37b are located adjacent to each other below the photosensitive drum 2 so that a certain range of the transfer belt 7 is in contact with the photosensitive drum 2.

A belt cleaning device 40 for cleaning the transfer belt 7 is located on the rear side of the driving roller 35 and below the rotary developing device 3. The belt cleaning device 40 includes a fur brush 41 located in a position facing the driving roller 35 and in sliding contact with the surface of the transfer belt 7, a cleaning roller 42 located above the fur brush 41 so as to be in contact with the fur brush 41, a blade 43 having a tip located so as to be in contact with a surface of the cleaning roller 42, and a recovery spiral 44 located below the blade 43 side by side.

In this cleaning device 40, matter attached to the intermediate transfer belt 7 is scraped off by the fur brush 41, and then recovered by the cleaning roller 42. The matter is then scraped off by the blade 43 from the surface of the cleaning roller 42 and recovered to a recovery unit (not illustrated) by the recovery spiral 44.

Secondary Transfer Roller

The secondary transfer roller 8 is a member to transfer the image transferred on the intermediate transfer belt 7 onto the conveyed sheet and is located below the driving roller 35 and facing the driving roller 35. Bias voltage is applied to the secondary transfer roller 8 by an energizing means (not illustrated) so as to transfer the image to the sheet.

Fixing Device

The fixing device 9 is a device to fix the toner image transferred onto the sheet by fusion and is located below the rotary developing device 3 and on the rear side in the device. The fixing device 9 includes a heating roller 9a having a built-in heater and a pressure roller 9b pressing against the heating roller 9a for pinching the sheet therebetween so as to convey the sheet.

Discharge Unit

In the printer 1, a discharge unit 50 is provided on a surface of an upper portion of the device, i.e., above the laser unit 4, the toner supply device 6, and the toner container 5, and sheets having images formed thereon are discharged thereto. The discharge unit 50 consists of a curved portion gradually increasing in height from the lowest portion on the laser unit 4 side (on the rear side in the device) to the other side on the toner container 5 side (on the front side in the device), and a flat portion continuous with the curved portion located above the toner container 5.

Sheet Feeding Unit

At the bottom of the device, the sheet feeding unit 51 for containing the sheets and launching out the sheets is provided. The sheet feeding unit 51 includes a sheet feeding cassette 52 having a stack plate on which the sheets are stacked, a forward feeding roller 53 and a multiple feeding prevention mechanism 54 for sending away paper by paper into the conveyance path. The sheet feeding cassette 52 can be pulled out toward the front side of the device.

Conveyance Mechanism

The conveyance mechanism for conveying sheets is located between the sheet feeding unit 51 and the discharge unit 50. The conveyance mechanism includes a first conveyance path 55 from the sheet feeding unit 51 to the secondary transfer roller 8, a second conveyance path 56 from the secondary transfer roller 8 to the fixing device 9, and a third conveyance path 57 from the fixing device 9 to the discharge unit 50. At an exit of the fixing device 9, a branching claw 58 is provided, and a return conveyance path 59 is provided between the branching claw 58 and a middle of the first conveyance path 55 for returning the sheet to the first conveyance path 55.

The first conveyance path 55 includes a curved path 55a for reversing the conveyance direction as well as conveying the sheet sent out from the sheet feeding cassette 52 upward, and a straight path 55b extending from the curved path 55a to the secondary transfer roller 8. These conveyance paths are composed of guide plates and pairs of rollers for guiding the sheets as well as conveying them, and include sensors installed at places for sensing the sheet. In addition, a pair of registration rollers 60 is provided in the straight path 55b for controlling conveyance timing of the sheet.

The second conveyance path 56 extends in a rectilinear direction, is composed of guide plates and pairs of rollers for guiding the sheets as well as conveying them, and includes sensors installed at places for sensing the sheet.

The third conveyance path 57 includes a vertical conveyance path formed downstream of the branching claw 58 in the conveyance direction. Namely, the sheet is conveyed upward in the vertical direction after passing the branching claw 58 and is discharged to the discharge unit 50. The third conveyance path 57 is also composed of guide plates and pairs of rollers for guiding the sheets as well as conveying them.

The return conveyance path 59 is a conveyance path which branches off downward from the third conveyance path 57 at a place where the branching claw 58 is mounted and extends below the fixing device 9, the second conveyance path 56, the secondary transfer roller 8 and the pair of the registration rollers 60, and then extends upward so as to join upstream of the pair of the registration rollers 60 in the first conveyance path 55 in the conveyance direction. Namely, the return conveyance path 59 is a conveyance path located vertically between the sheet feeding cassette 52 and straight path 55b of the first conveyance path 55 as well as the second conveyance path 56. The path 59 returns the sheet passed through the fixing device 9 upstream of the pair of the registration rollers 60, which is located upstream of the secondary transfer roller 8. The return conveyance path 59 is also composed of guide plates and pairs of rollers for guiding the sheets as well as conveying them, and includes sensors installed at places for sensing the sheet.

Sheet Feeding Tray

Below the toner container 5 and above the sheet feeding cassette 52, the sheet feeding tray 65 is provided so as to form a lateral wall on the front side of the device. The sheet feeding tray 65 has a lower end pivotably supported in the vicinity of the curved path 55a of the first conveyance path 55 such that the sheet feeding tray 65 can take an open position and a closed position. The upper end of the sheet feeding tray 65 can be reclined toward the front side of the device around a rotation center 65a in the lower end. Accordingly, when the sheet feeding tray 65 is opened, it is possible to put the sheet on the sheet feeding tray 65 and supply the curved path 55a of the first conveyance path 55 with the sheets.

Image Forming Operation

Next, the image forming operation will be explained in a simplified manner. First, when the power is applied to the color printer 1, a variety of parameters are initialized and initialization is executed such as setting a temperature of the fixing device. Then, when the image data from the computer connected to this printer is inputted and an instruction to start printing is given, the image forming operation is carried out as following. It should be noted that during the image forming operation the toner supply pipe 25 is moved to the retracted position upward so that the laser path is not blocked by the toner supply pipe 25.

First, the charge roller 10 charges the photosensitive drum 2. After that, the photosensitive drum 2 is scanned and exposed by the laser unit 4 in accordance with the image data so that the electrostatic latent image is formed on the photosensitive drum 2. Next, the rotary developing device 3 is rotated and the developing unit 16 whose color is designated is opposed to the photosensitive drum 2. In this state, the electrostatic latent image on the photosensitive drum 2 is developed with the designated toner color. The developed image is transferred to the intermediate transfer belt 7. The above-mentioned operation is sequentially carried out color by color so that the full color image is formed on the intermediate transfer belt 7. It should be noted that residual toner on the photosensitive drum 2 is cleaned by the drum cleaning device 11 and is discarded into a discarded toner container (not illustrated).

In the sheet feeding unit 51, a sheet is taken out from the sheet feeding cassette 52 by the forward feeding roller 53 and multiple feeding prevention mechanism 54, and is conveyed to the pair of the registration rollers 60 through the first conveyance path 55. Then, the sheet is conveyed from the pair of the registration rollers 60 to the intermediate transfer belt 7 with timing of image forming thereon and guided to the secondary transfer roller 8. The secondary transfer roller 8 is in contact with the intermediate transfer belt 7 and the full color image formed on the intermediate transfer belt 7 is transferred to the sheet by transfer bias applied to the secondary transfer roller 8. The sheet is guided to the fixing device 9 through the second conveyance path 56, and the image is fixed to the sheet by heat and pressure in the fixing device 9. In the case of one-side printing, the sheet is guided to the third conveyance path 57 by means of the branching claw 58, and then is discharged to the discharge unit 50.

In the case of double-side printing, after fixation in the fixing device 9, the sheet is guided by the branching claw 58 toward a side of the return conveyance path 59 and is returned to the first conveyance path 55 again. The sheet is temporarily stopped by the pair of the registration rollers 60. The sheet is sent at a predetermined timing toward the secondary transfer roller 8 after the rear side image is formed on the intermediate transfer belt 7 in the same operation mentioned before. After that, the same operation is carried out and the sheet is guided toward the third conveyance path 57 by means of the branching claw 58 and is discharged to the discharge unit 50.

Toner Supply Operation

When the toner is supplied to the developing units 16, the rotary developing device 3 is rotated such that the developing unit 16 to which the toner will be supplied is positioned in the supply position as shown in FIG. 1. The rotary developing device 3 is locked so as not to rotate in this state. Next, the toner supply pipe 25 is moved downward to the supply position. More specifically, the motor (not illustrated) drives the pinion gear 33 with the gears so that the toner supply pipe 25 to which the rack 32 is fixed is moved downward. Meanwhile, the toner is supplied to the toner supply pipe 25 from the toner container 5 through the conveyance pipe 26. The tip of the toner supply pipe 25 goes through the slit 18a as a toner supply opening and into the developing unit 16. During the downward movement of the toner supply pipe 25, the outer cylinder rotates relative to the inner cylinder. Upon the entry of the tip of the toner supply pipe 25 into the developing unit 16, the openings of the outer cylinder and the inner cylinder correspond to each other. In other words, the shutter mechanism is opened so that the toner inside of the toner supply pipe 25 is supplied into the developing unit 16.

It should be noted that although the toner supply pipe 25 blocks the laser light path from the laser unit 4 to the photosensitive drum 2 when toner supply pipe 25 is positioned in the supply position, it is not a cause for concern because the toner supplying operation by the toner supply pipe 25 and the image forming operation are not carried out simultaneously.

In this embodiment, the black developing unit 16B employs the magnetic one-component developing system and the color developing units 16Y, 16M, and 16C, except for black, employ the non-magnetic one-component toner so that it is possible to extend the product lifespan of the color printer 1 as well as reducing the color printer 1 in size and in cost.

In addition, the diameters of the non-magnetic developing rollers 70Y, 70M, and 70C are set smaller than that of the magnetic developing roller 70B so that resisting torque generated by making the toner control blade or the sponge roller contact against the outer circumference of the non-magnetic developing roller becomes smaller, which means that torque required for driving the non-magnetic developing rollers 70Y, 70M, and 70C is prevented from increasing.

In this embodiment, the intermediate gear 83 is located between the input gear 84 and the paddle driving gear 82. As a result, although the positional relationship of the input gear 84 and the paddle driving gear 82 in the black developing unit 16B is different from positional relationship of the input gear 84 and the paddle driving gear 82 in the color developing units 16Y, 16M, and 16C, the driving force is smoothly transmitted between both the gears.

Any terms of degree used herein, such as “substantially”, “about” and “approximately”, mean a reasonable amount of deviation of the modified term such that the end result is not significantly changed. These terms should be construed as including a deviation of at least ±5% of the modified term if this deviation would not negate the meaning of the word it modifies.

This application claims priority to Japanese Patent Application No. 2004-316784. The entire disclosure of Japanese Patent Application No. 2004-316784 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

What is claimed is:

1. A color image developing device, comprising:
a black developing unit having a magnetic developing roller, the black developing unit developing a black toner image with a magnetic one-component toner; and
a plurality of color developing units having non-magnetic developing rollers, the plurality of color developing units developing a color toner image, except for black, with a non-magnetic one-component toner;
wherein the diameters of the non-magnetic rollers are smaller than the diameter of the magnetic developing roller.

2. A color image developing device according to claim 1, wherein the non-magnetic developing rollers include a solid roller main body and a rubber layer formed on a surface of the roller main body.

3. A color image developing device according to claim 1, further comprising a rotary frame that serves to maintain the black developing unit and the plurality of color developing units in a circumferential direction, and place each of the developing units opposite an image bearing member by means of rotation.

4. A color image developing device according to claim 1, further comprising:
agitation members rotatably arranged in the developing units, the agitation members agitating the toner;
a magnetic developing roller driving gear mounted on an axial end of the magnetic developing roller of the black developing unit;
non-magnetic developing roller driving gears mounted on axial ends of the non-magnetic developing rollers of the color developing units;
agitation member driving gears fixed to axial ends of the agitation members and engaged with the roller driving gears;
input gears rotatably mounted on axial ends of the developing units, to which power is inputted from an external driving mechanism; and
intermediate gears engaged with the input gears and the agitation member driving gears of the developing units;
wherein the input gears of the developing units are located in the same position relative the external driving mechanism; and
the positions of the agitation member driving gear and the intermediate gear relative to the input gear and the roller driving gear in the black developing unit are different from the positions of the agitation member driving gear and the intermediate gear relative to the input gear and the roller driving gear in the color developing units.
